(19) United States
(12) Patent Application Publication
(10) Pub. No.: US 2011/0218973 A1
(43) Pub. Date: Sep. 8, 2011

(54) SYSTEM AND METHOD FOR CREATING A DE-DUPLICATED DATA SET AND PRESERVING METADATA FOR PROCESSING THE DE-DUPLICATED DATA SET

(75) Inventors: Kenneth C. Pendlebury, Georgetown, TX (US); Christopher K. Pratt, Houston, TX (US); Harold Marchand, Austin, TX (US); Terence C. Jones, Austin, TX (US)

(73) Assignee: RENEW DATA CORP.

(21) Appl. No.: 13/039,269

(22) Filed: Mar. 2, 2011

Related U.S. Application Data
(60) Provisional application No. 61/309,841, filed on Mar. 2, 2010.

(51) Int. Cl. G06F 17/30

(52) U.S. Cl. 707/692; 707/E17.005

(57) ABSTRACT

The present invention provides a system and method for de-duplicating a large heterogeneous stock of data and collecting metadata associated with that data. Additionally, the system and method provide a means for retrieving data items based on specific criteria that can be identified in the collected metadata.

### PRIORITY CLAIM

The present invention claims the benefit under 35 U.S.C. §119(e) of U.S. Provisional Patent Application No. 61/309,841 filed on Mar. 2, 2010 and entitled “System And Method For Creating A De-Duplicated Data Set And Preserving Metadata For Processing The De-Duplicated Data Set,” the contents of which are incorporated herein by reference and are relied upon here.

### RELATED APPLICATIONS

The present application describes a system and method that can operate independently or in conjunction with systems and methods described in pending U.S. application Ser. No. 10/759,599, filed on Jan. 16, 2004, and entitled “System and Method for Data De-Duplication,” which is hereby incorporated herein by reference in its entirety.

### FIELD OF THE INVENTION

The present invention generally relates to systems and methods for de-duplicating data files, collecting metadata from data files, and searching/reporting/culling metadata and corresponding data files.

### BACKGROUND

Although platforms for collecting, de-duplicating and processing various data exist, there is a need for a widely-scalable, data-agnostic, high-speed systems and methods for de-duplicating data, collecting metadata and searching/culling/reporting metadata for messaging data and file system data. In particular, there is a need for such systems and methods that are suitable for wide scalability at low cost while maintaining high operating speeds. Further, there is a need for such systems and methods to be flexible so that they can be deployed at a client's location, potentially behind a secure firewall, which facilitates on-site file deduplication and metadata collection.

### SUMMARY

The present invention is directed to a system and method for de-duplicating data items, collecting metadata associated with data items and searching/culling/reporting the collected metadata to produce a select subset of data.

In accordance with one aspect of the invention, provided is a high-speed de-duplication system comprising one or more pods in communication with a file system. The one or more pods traverse data items, and create hashes for the data items. Once a pod creates a hash for a data item, the pod attempts to store the data item in the file system. If a data item with the same hash value is already stored in the file system, the pod will not be able to store that data item in the file system. If there is no other data item in the file system with the same hash value, the pod stores data item in the file system. A pod may be any general computing system that can perform various tasks associated with file handling such as data traversal and hashing. Data may be stored and processed by the pods in any number of formats.

In accordance with another aspect of the invention, the pods traverse the file system, containing de-duplicated and hashed data, to collect and store metadata in a database. For example, the pods may traverse data that is de-duplicated and hashed by the pods and stored in the file system. The data de-duplication and the metadata traversal may be performed in parallel or in series by the same pods or different pods. Metadata is preferably stored in a database based on prescribed or automatically determined categories/fields that may be contained in the metadata. The metadata corresponding to a particular data item is preferably associated with that data item's file source information, such as the item's hash value.

In accordance with yet another aspect of the invention, once the metadata traversal and storage is complete, the database storing the metadata may be queried based on specified parameters and all data items identified by the metadata query may be retrieved from the filing system. Thus, metadata queries may be used to create or restore certain data structures, such as a custodian mail box or system file, simply by querying the database for the proper metadata parameters.

Yet another aspect of the invention is the automatic or manual creation of metadata term equivalencies for metadata queries. Term equivalencies may be used to expand the scope of a query to encompass not only a term included in the database query but also any equivalents of that term. Term equivalencies may be manually established by a user and/or they may be automatically established by the pods during the metadata traversal/collection process. Term equivalents may be stored in multiple ways in the database schema, such as through cross linking or other well known methods in the art for establishing equivalency relationships and networks.

In yet another aspect of the invention, the two processes—de-duplication and metadata searching/culling/reporting—are performed serially in a continuous manner for each data item. Thus, after a pod has de-duplicated a data item (i.e. confirmed that the data item may be successfully added to the file system), the pod will immediately perform the metadata searching, culling and reporting.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. It should be understood that these drawings depict only exemplary embodiments of the invention and therefore, should not be considered to be limiting of its scope. The invention will be described and explained with additional specificity and detail through the use of the accompanying drawings in which:

FIG. 1 is a diagram a system in accordance with an exemplary embodiment of the invention;

FIG. 2 is a flow diagram illustrating an exemplary implementation of a method for de-duplicating data items and collecting metadata associated with data items in accordance with the invention;

FIG. 3 is a flow diagram illustrating an exemplary implementation of a de-duplication method in accordance with the invention;

FIG. 4 is a flow diagram illustrating an exemplary implementation of a method for collecting and storing metadata;

FIG. 5 is a flow diagram illustrating an exemplary implementation of a method for searching/culling/reporting collected metadata to produce a select subset of data in accordance with the invention; and

FIG. 6 illustrates various examples of system inputs, requests or queries and their corresponding system outputs.

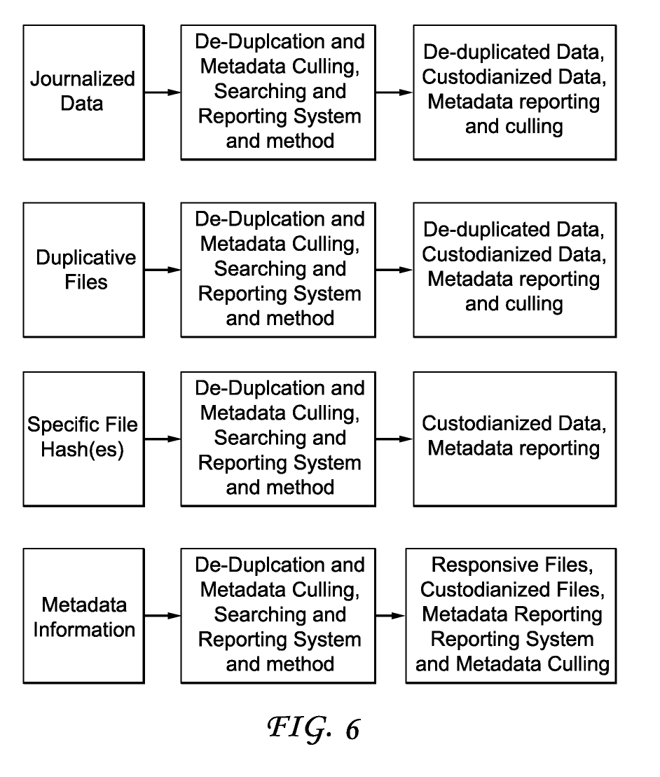

### DETAILED DESCRIPTION

Various embodiments of the invention are described in detail below. While specific implementations involving electronic devices (e.g., computers) are described, it should be understood that the description here is merely illustrative and not intended to limit the scope of the various aspects of the invention. It should also be recognized that other components and configurations may be easily used instead of or substituted for those that are described here without departing from the spirit and scope of the invention.

Moreover, it should be appreciated that the invention may be practiced with any number of computer system configurations including, but not limited to, distributed computing environments where tasks are performed by remote processing devices that are linked through a communications network. In a distributed computing environment, program modules may be located in both local and remote memory storage devices. The present invention may also be practiced in and/or with personal computers (PCs), hand-held devices, multiprocessor systems, microprocessor-based or programmable consumer electronics, network PCs, minicomputers, mainframe computers, and the like.

Further, methods in accordance with the principles of the present invention are described below and shown in the figures with reference to particular exemplary embodiments. Thus, it should be appreciated that the sequence or order of the operation flows described and shown herein can be varied without departing from the scope of the present invention. Also, it should be appreciated that some steps in the operation flows described and shown herein can be added, merged, and/or eliminated depending on the particular application without departing from the scope of the present invention.

The present invention is directed to a system 100 and method for de-duplicating data items, collecting metadata associated with data items, and/or culling the collected metadata to produce a select subset of data.

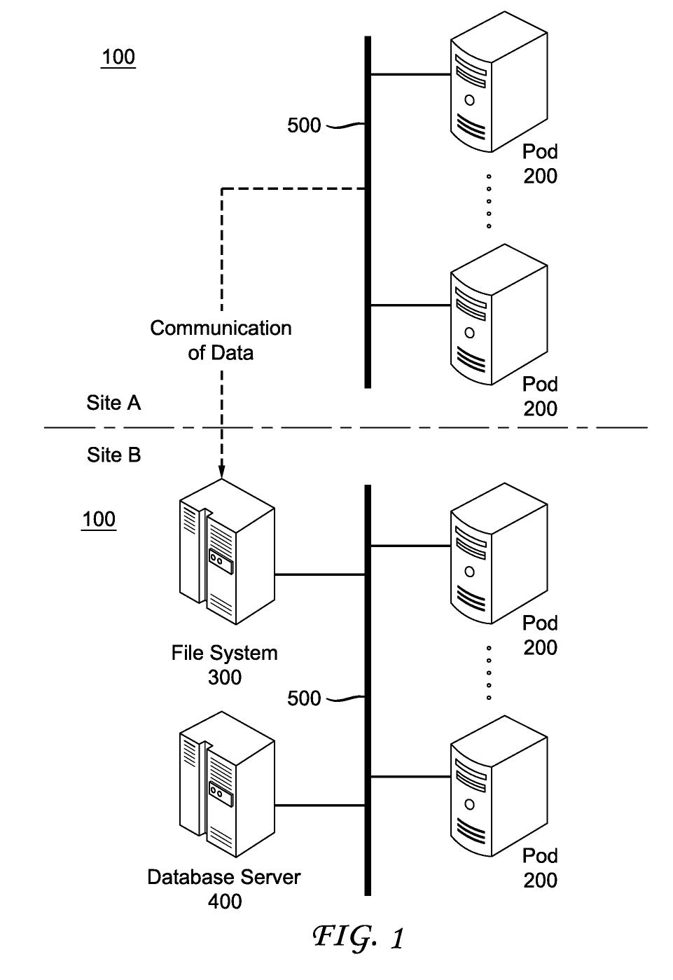

In accordance with one aspect of the invention, as shown in FIG. 1, provided is a system 100 comprising one or more “pods” 200, a central file system 300 and a database system 400 connected together to form a network, such as a Local Area Network (LAN), Wide Area Network (WAN), or other type of network. The pods 200, file system 300 and database system 400 may be connected together by any suitable means 500 known in the art, and are preferably connected through some wired or wireless networking technology. For example, the pods 200, file system 300 and database system 400 may be connected through Ethernet and/or WiFi, or through any other known means 500 of communicating information over a wireless or wired medium.

In a preferred embodiment, a pod 200 may be any general computing system that can perform various tasks associated with file handling such as, data de-duplication and metadata traversal/collection. The pods 200 may be any type of general computing device which may be connected externally or internally through any means known in the art. Further, the pods 200 may be either physical hardware or virtualized systems running on a central computing device. The system's pods 200 may be specifically dedicated to perform specific tasks, specifically partitioned to perform specific tasks, allowed to perform tasks based on processing demands and availability, or any combination thereof.

The central file system 300 may be a centralized or distributed file system that can be centrally identified, consolidated and addressed. The file system 300 is preferably adapted to be accessed by all the pods 200 and database system 400 such that all addressing is invariant of the computing system accessing the storage. The file system 300 is accessible by all pods 200 and provides storage of data communicated by the pods 200.

Generally, the database system 400 communicates with the pods 200 and file system 300, and receives and processes metadata corresponding to the data items stored on the file system 300. The database system 400 may be any database system such as, for example, a MySQL database or an oracle database system.

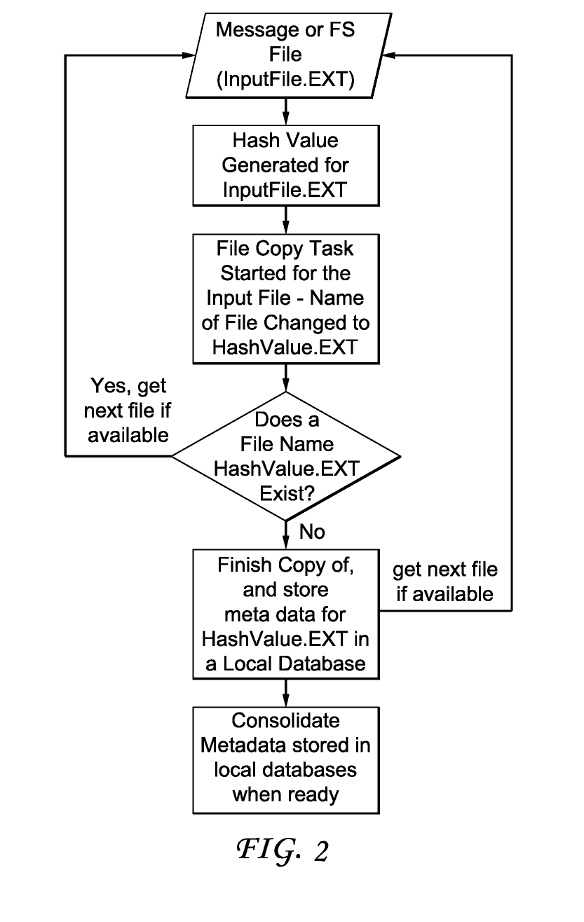

In one embodiment the data to be de-duplicated may be placed on individual pods 200. The data may be placed on the pods 200 through some physical means, such as by mounting hard disks on the pods 200, where a hard disk may be any device that can store information when connected to a computer (e.g. tapes, hard drives, diskettes, flash drives or another known devices in the art). As shown in FIG. 2, each pod 200 then traverses every data item placed thereon, hashes every data item, and creates a representative file that is named with the hash value generated from the data item. The pod 200 then attempts to copy the data item into the file system 300. If a data item with the same hash value is already stored in the file system 300, the pod 200 will not be able to store that data item in the file system 300. If there is no other data item in the file system 300 with the same hash value, the pod 200 stores data item in the file system 300. Once there are data items in the file system 300, pods 200 can begin to collect metadata from every data item in the file system 300 and place the metadata associated with a data item in the file system 300 into the database system 400. Different pods 200 or the same pods 200 may traverse and collect metadata from a data set after the data-set has been de-duplicated.

In another embodiment the system 100 and method may function just as the above embodiment, but instead of having the data directly put onto the pods 200, the pods 200 themselves might retrieve the data through some communicative means. The pods 200 may retrieve the data over some wired or wireless connection between the pods 200 and one or more systems or devices containing data to be de-duplicated. The pods 200 in this embodiment might not be local to the data to be de-duplicated.

In another embodiment the system 100 and method may function just as the above embodiments, however, the two processes—data de-duplication and metadata searching/culling/reporting—may be performed serially in a continuous manner for each data item. Thus, after a pod 200 has de-duplicated a data item (i.e. confirmed that the data item may be successfully added to the file system 300), the pod 200 will immediately perform the metadata collection.

In another embodiment, the de-duplication and metadata collection may occur at separate locations. Although pods 200 may be transported to a remote site (e.g. client site) to perform data de-duplication, preferably, pod software is installed on the machines at the remote site (e.g. client site) that contain the data to be de-duplicated or that have access to the data to be de-duplicated. The de-duplicated data is then stored on a file system 300, which may be local (e.g. vendor site) or remote to the pods 200 that performed the data-de-duplication. Thus, the de-duplicated data may be stored on a file system 300 by transferring the data through a communication link, or alternatively, the de-duplicated data may be physically transported and stored on a file system 300. Once the de-duplicated data is stored in the file system 300, a local set of pods 200 (e.g. pods at a vendor site) can begin to collect metadata from every data item in the file system 300 and place the metadata associated with a data item in the file system 300 into the database system 400. Alternatively, de-duplicated data stored on a file system 300 by pods 200 at one site can be transported to another site where pods 200 can collect metadata at a later time.

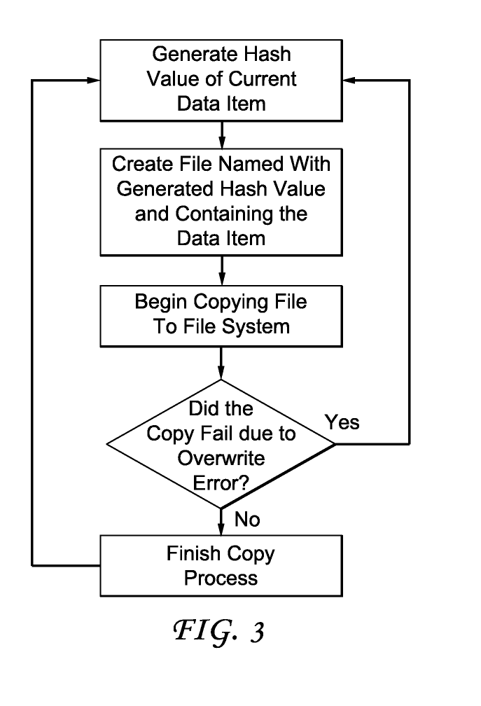

In accordance with one aspect of the invention, as shown in FIG. 3, the pods 200 preferably perform data de-duplication on a completely data agnostic basis, meaning that the pods 200 are capable of generating a hash value for data for any file format. The hashing of data may be performed in accordance with well known hashing methods in the art. Generally, hashing refers to the creation of a unique value (“hash key”) based on the contents of a data file. A preferred exemplary hashing process is fully disclosed in U.S. patent application Ser. No. 10/759,599, filed on Jan. 16, 2004, and entitled “System and Method for Data De-Duplication (RENEW1120-3), which is incorporated by reference herein in it entirety. In a preferred implementation, each hash key generated for a data file is a SHA1 type hash.

Hash algorithms, when run on content, produce a unique value such that if any change (e.g., if one bit or byte or one change of one letter from upper case to lower case) occurs, there is a different hash value for that changed content. This uniqueness is somewhat dependent on the length of the hash values, and as apparent to one of ordinary skill in the art, these lengths should be sufficiently large to reduce the likelihood that two files with different content portions would hash to identical values. When assigning a hash value to the content of a data item, the actual stream of bytes that make up the content may be used as the input to the hashing algorithm.

In one embodiment, the hash algorithm may be the SHA1 secure hash algorithm number one—a 160-bit hash. In other embodiments, more or fewer bits may be used as appropriate. A lower number of bits may incrementally reduce the processing time, however, the likelihood that different content portions of two different files may be improperly detected as being the same content portion increases. After reading this specification, skilled artisans may choose the length of the hashed value according to the desires of their particular enterprise.

Referring to FIG. 3, after generating a hash value for a particular data item, the pod 200 attempts to add a copy of the file to the common file system 300 by comparing the hash value of a particular data item to the hash values of data items already stored in file system 300. If the same hash value has not been previously stored in system 300, this indicates that the same data item is not already stored in system 300. If there is no other data item in the file system 300 with the same hash value, the pod 200 adds the data item to the file system 300. If during this comparison, however, the hash value is identical to a previously stored hash value, this indicates that an identical data item has already been stored in system 300. If a data item with the same hash value is already stored in the file system 300, the pod 200 will not be able to add that data item to the file system 300 as identical content is already present in system 300

In certain embodiments, there may be rules which specify when to store content regardless of the presence of identical content in system 300. For example, a rule may exist that dictates that if content is part of an email attachment to store this content regardless whether identical content is found in system 300 during this comparison. Additionally, these type of rules may dictate that all duplicative content is to be stored unless it meets certain criteria. The adding or copying of data items to the file system 300 may be performed through any suitable methods known in the art. Though not required, the data items are preferably stored and organized into a folder directory where the partitioning of the data into folders is based on their hash values, similar to well known standard caches for increasing access speeds.

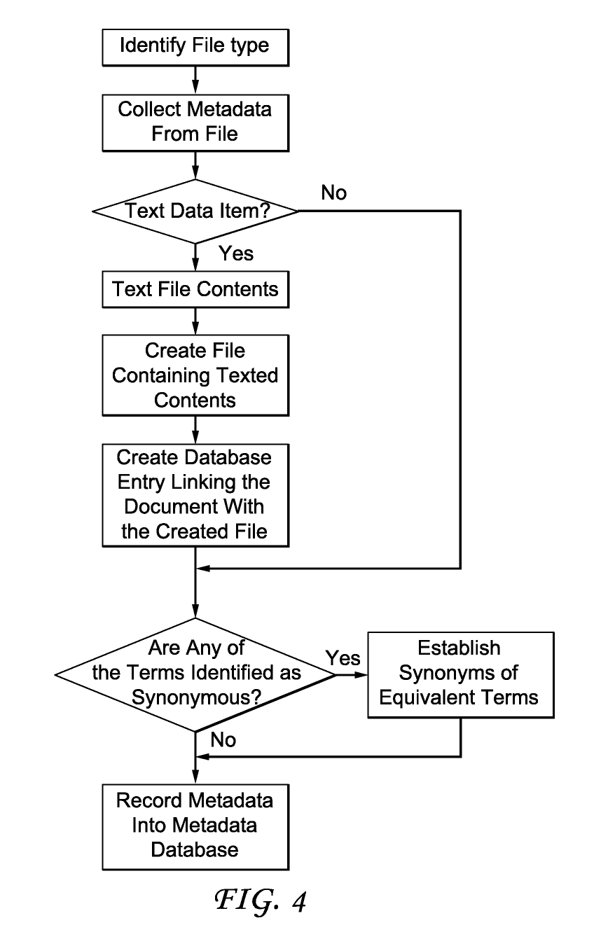

In accordance with another aspect of the invention, as shown in FIG. 4, the pods 200 traverse a preferably de-duplicated data set stored in the centrally accessible file system 300 and collect/extract metadata and create a database 400 of the metadata. The metadata corresponding to a particular data item is preferably associated with that data item's file source information, such as the item's hash value. The metadata is properly categorized and stored in the database 400 based on the particular schema employed. Different file types that store metadata in different ways may be processed using suitable methods known in the art, such as plug-ins to process specific file formats.

In accordance with another aspect of the invention, as shown in FIG. 4, the pods 200 traverse a preferably de-duplicated data set stored in the centrally accessible file system 300 and text the data items contained in the file system 300. Texting is a process of converting files, irrespective of file format, to a standard text file format that can be processed by conventional review tools. The text file corresponding to a particular data item is preferably associated with that data item's file source information (e.g. the item's hash value) and is stored in, for example, a database which may be the same or different than the database 400 in which metadata is stored.

The system's pods 200 may be specifically dedicated to perform specific tasks, specifically partitioned to perform specific tasks, allowed to perform tasks based on processing demands and availability, or any combination thereof. Thus, different pods 200 or the same pods 200 may perform the same or different functions at the same time or at different times. For example, the pods 200 may traverse and collect metadata from a data set after they complete de-duplicating that data-set. Alternatively, the pods 200 may traverse and collect metadata from some portions of a data set while they are still de-duplicating other portions of the data-set. If the same pods 200 are used for both data de-duplication and metadata traversal/collection, the metadata traversal/collection may occur once a pod 200 or some portion thereof becomes available after de-duplicating data for which it is responsible. In another example, one set of pods 200 may traverse and collect metadata from a data set after a different set of pods 200 has completed de-duplicating that data-set. Alternatively, one set of pods 200 may traverse and collect metadata from some portions of a data set while a different set of pods 200 is still de-duplicating other portions of the data-set. In yet another example, the pods 200 may traverse and collect metadata from a data set that has been de-duplicated outside of the system. Thus, in some embodiments, the data de-duplication and the metadata traversal/collection may occur within the system at the same location and, in other embodiments, the data de-duplication and the metadata traversal/collection may occur at disparate locations by completely separate machines.

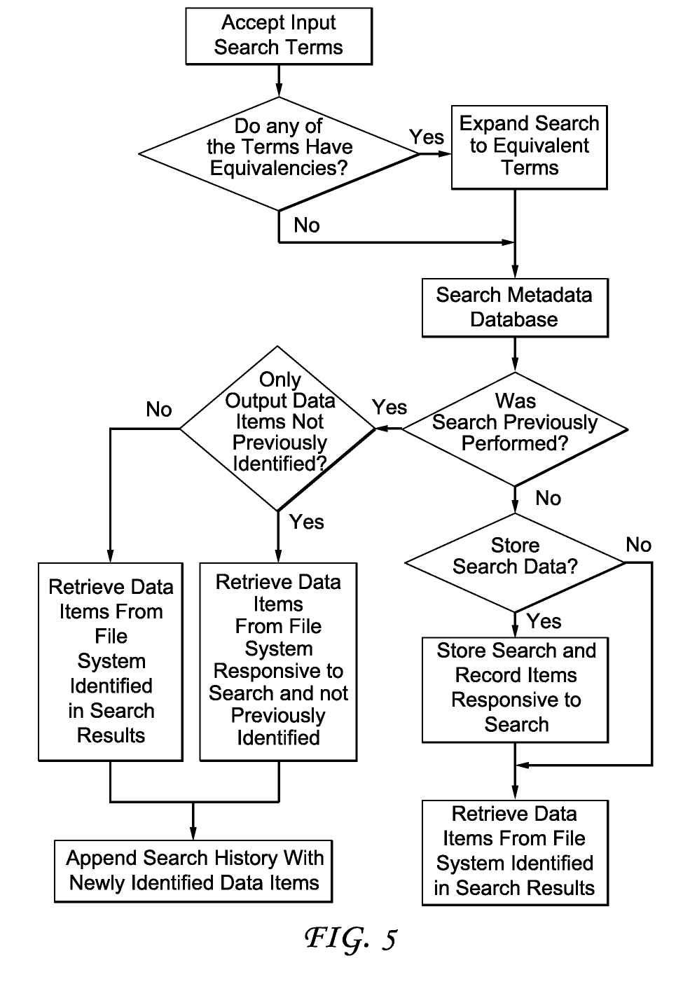

In accordance with yet another aspect of the invention, as shown in FIG. 5, the metadata stored in the database 400 may be queried based on specific metadata parameters to identify specific data items of interest in the central file system 300. Data items pertaining to a query are preferably identified by their hash values so that they can be easily retrieved from the central filing system. Thus, metadata queries may be used to produce certain data items from the file system 300 and create or restore certain data structures, such as a custodian mail box or system file, simply by querying the database 400 for the proper metadata parameters. Also, for example, data associated with a particular custodian may be searched. Further, any metadata stored can be searched, culled and/or reported to produce or exclude data sets.

In accordance with another aspect of the present invention, as shown in FIG. 5, data items pertaining to a query may be produced on a rolling basis. In other words, as new data items that are responsive to a previous query are added to the system, these data items may be produced/identified as responsive to an existing query. Thus, search queries may be stored by the database 400 so that responsive data items may be produced on a rolling basis. As additional data items are processed and entered into the system, stored search queries may be automatically re-run or re-run on demand to identify additional responsive data items. Preferably, the stored queries are re-run to return only responsive data items that had not been previously identified by previous queries.

In accordance with yet another aspect of the invention, as shown in FIG. 5, database queries preferably employ a set of term equivalencies for a particular search term so that the database 400 can identify data that includes metadata terms that are different from the particular search term. As shown in FIG. 4, term equivalencies may be manually established by a user and/or they may be automatically established by the pods 200 during the metadata traversal/collection process. For example, term equivalencies may be automatically established during the metadata traversal/collection by identifying various possible synonymous terms or identifiers that are used to represent the same concepts, ideas, or entities in the data so recorded. For example, in an email file, a sender may be explicitly identified through multiple aliases, which may be automatically linked together and to other terms that have already been linked to any of the terms to create a set of equivalent terms. Term equivalents may be stored in multiple ways in the database schema, such as through cross linking or other well known methods in the art for establishing equivalency relationships and networks.

In an exemplary embodiment, the present invention may be used to de-duplicate data and collect data from a Mail store and any back up versions. For example, pod software may be installed on one or more machines and pointed to specific locations where backed up EDB files or PST files reside. The EDB files or PST files may be remote or local to the machine running the pod software. The pods 200 may traverse the EDB and PST files and extract, for example, individual email messages and attachments. As the pods 200 traverse the EDB files or PST files, the pods 200 generate hash values for each email message or attachment and create a file containing all of the contents of the message or attachment and name the file with the hash value generated. The pod 200 then attempts to copy the email message or attachment into the file system 300 as described above.

Once the de-duplicated data has been stored in the file system 300, the pods 200 then begin to perform the metadata collection. The pods 200 performing the metadata collection may be the same pods 200 or different than the pods 200 that performed the data de-duplication. The metadata contained email messages in EDB or PST files may include, but is not limited to, sender information such as name, mailbox addressor Exchange identifier, Recipient information such as mail box address, Exchange identifier or recipient name, data/time the message was created, received or sent, message routing information, email client data, subject, etc. In this embodiment, equivalencies may be established, for example, by associating multiple aliases defined for a single sender or recipient in the same message. After all data items in the de-duplicated data have had their metadata collected and placed into the database system 400, the database 400 may be searched based on the fields contained in the database 400 and based on the metadata stored.

What is claimed is:

1. A method for de-duplicating and storing data, comprising the steps of:
reading the contents of a data file;
generating a hash value for the data file;
comparing the hash value with existing hash values;
storing the data file if its hash value does not match an existing hash value;
extracting metadata from the stored data file; and
storing the metadata and associating the metadata with the data file's hash value such that the metadata can be queried to identify the corresponding data file.

2. A system for de-duplicating and storing data, comprising:
at least one pod adapted to read the content of a data file and generate a hash value corresponding to the data file;
a file system in communication with the at least one pod, adapted to store the data file and its hash value if its hash value does not match the hash value of a data file already stored in the file system; and
a database system in communication with the at least one pod and the file system, wherein the database system is adapted to receive and process metadata corresponding to the data file stored on the file system, and wherein the database stores the metadata and associates the metadata with the data file's hash value such that the metadata can be queried to identify the corresponding data file.
